(19) United States
(12) Patent Application Publication
(10) Pub. No.: US 2015/0372808 A1
(43) Pub. Date: Dec. 24, 2015

(54) PRIVATE AND DISTRIBUTED COMPUTATION OF PROBABILITY DENSITY FUNCTIONS

(71) Applicant: Palo Alto Research Center Incorporated, Palo Alto, CA (US)

(72) Inventors: Igor Bilogrevic, Vezia (CH); Julien F. Freudiger, Mountain View, CA (US); Emiliano De Cristofaro, London (GB); Ersin Uzun, Campbell, CA (US)

(21) Appl. No.: 14/308,639

(22) Filed: Jun. 18, 2014

(51) Int. Cl. H04L 9/08; G06N 7/00; H04L 9/16

(52) U.S. Cl. CPC H04L 9/0819; H04L 9/16; G06N 7/005; H04L 2209/24

(57) ABSTRACT

One embodiment of the present invention provides a system for privacy-preserving aggregation of encrypted data. During operation, the system distributes secret keys to a plurality of devices. The system receives at least a pair of encrypted vectors from each device of a subset of the plurality of devices. One of the encrypted vectors is associated with a set of numerical values and the other encrypted vector is associated with corresponding square values of the set of numerical values. Each pair of encrypted vectors is encrypted using a respective secret key distributed to a device of the plurality of devices. The system then computes, for each pair of encrypted vector elements associated with a numerical value and a square of the numerical value, a mean and variance of a probability density function. The system then generates a plurality of probability density functions based on the computed mean and variance values.

### RELATED APPLICATION

The subject matter of this application is related to the subject matter of the following application:
U.S. patent application Ser. No. 13/021,538 (Attorney Docket No. PARC-20100996-US-NP), entitled “PRIVACY-PRESERVING AGGREGATION OF TIME-SERIES DATA,” by inventors Runting Shi, Richard Chow, and Tsz Hong Hubert Chan, filed Feb. 4, 2011;
   the disclosure of which is incorporated by reference in its entirety herein.

### BACKGROUND

1. Field

The present disclosure relates to privacy-preserving data aggregation. More specifically, this disclosure relates to a method and system for aggregating encrypted user attribute data and computing probability density functions in a distributed and privacy-preserving way.

2. Related Art

The digital footprint of Internet users is growing at an unprecedented pace, boosted not only by the increasing number of activities performed online, but also by the billions of posts, likes, check-ins, and multimedia content shared everyday. This creates invaluable sources of information that one may use to profile users and serve behavioral targeted advertisement. With $8 Billion annual revenue in 2013, Facebook is a prime example of a company successfully monetizing personal data with advertisers and data brokers.

This economic model, however, raises major privacy concerns as advertisers might excessively track users, data brokers might illegally market consumer profiles, and governments might abuse their surveillance power by obtaining datasets collected for monetization purposes. Consequently, consumer advocacy groups pressured for policies and legislations that provided greater control to users and more transparent collection practices (e.g., the European Union cookie law).

Along these lines, several efforts—such as OpenPDS, personal.com, Sellbox, and Handshake—advocate a novel, user-centric paradigm. Users store their personal information in “data vaults,” and directly manage with whom to share their data. This approach has several advantages, including that users maintain data ownership and may monetize their data, and data brokers and advertisers benefit from more accurate and detailed personal information. Nevertheless, privacy still remains a challenge as users need to trust data vault operators and relinquish their profiles to advertisers.

To address these concerns, the research community proposes to maintain data vaults on user devices and share data in a privacy-preserving way. Existing solutions can be grouped into three categories: methods that (1) run advertising locally without revealing any information to advertisers/data brokers (2) rely on a trusted third party to anonymize user data, and (3) rely on a trusted third party for private user data aggregation. Unfortunately, these approaches suffer from several limitations which hinder their adoption. Localized methods prevent data brokers and advertisers from obtaining user statistics. Anonymization techniques provide advertisers with significantly reduced data utility and are prone to re-identification attacks. Finally, existing private aggregation schemes rely on a trusted third party for differential privacy (e.g., a proxy, a website, or mixes). Also, aggregation occurs after decryption, thus making it possible to link contributions and users.

### SUMMARY

One embodiment of the present invention provides a system for privacy-preserving aggregation of encrypted data. During operation, the system distributes secret keys to a plurality of devices. The system receives at least a pair of encrypted vectors from each device of a subset of the plurality of devices. One of the encrypted vectors is associated with a set of numerical values and the other encrypted vector is associated with corresponding square values of the set of numerical values. Each pair of encrypted vectors is encrypted using a respective secret key distributed to a device of the plurality of devices. The system then computes, for each pair of encrypted vector elements associated with a numerical value and a square of the numerical value, a mean and variance of a probability density function. The system then generates a plurality of probability density functions based on the computed mean and variance values.

In a variation on this embodiment, a sum of the respective secret keys distributed to each of the plurality of devices plus a secret key of an aggregator is equal to zero.

In a variation on this embodiment, generating the plurality of probability density functions comprises generating one or more probability density functions of Gaussian distributions.

In a variation on this embodiment, the encrypted vectors are received from users associated with the devices in exchange for a benefit of economic value to the users as part of a monetizing and/or advertising program.

In a variation on this embodiment, computing the mean and variance further comprises computing intermediate values {Vⱼ, W₁} by computing the expressions:

Vⱼ=H(t)^{s}^{₀}Πᵢ₌₁^{N}c_{i,j}

Wⱼ=H(t)^{s}^{₀}Πᵢ₌₁^{N}b_{i,j}

such that b_{i,j} and c_{i,j} represent the encrypted data of each user i for an attribute j in a group of N users, s₀ represents the secret key for an aggregator, and H(t) represents a hash function at time t.

In a variation on this embodiment, computing the mean and the variance \hat{σ}ⱼ² associated with an attribute j comprises computing the expressions:

$${\hat{μ}}_{j} = \frac{{log}_{g} ( {V}_{j} )}{N}$$

$${\hat{σ}}_{j}^{2} = \frac{{log}_{g} ( {W}_{j} )}{N} - {\hat{μ}}_{j}^{2}$$

such that g represents the generator and N represents a number of users.

### BRIEF DESCRIPTION OF THE FIGURES

FIG. 1A presents a block diagram illustrating an exemplary context of a privacy-preserving aggregation system, according to an embodiment.

FIG. 1B presents a block diagram illustrating an exemplary system architecture of a privacy-preserving framework for aggregating and monetizing user data, according to an embodiment.

FIG. 2 presents a flowchart illustrating an exemplary process for estimating a probability density function, according to an embodiment.

FIG. 3A and FIG. 3B present a flowchart illustrating an exemplary privacy-preserving process for aggregating and monetizing user profile data, according to an embodiment.

FIG. 4 presents a table illustrating a summary of a U.S. Census dataset used for evaluation.

FIG. 5A-5C presents graphs illustrating Gaussian approximations versus actual distributions for an income attribute.

FIG. 5D-5F presents graphs illustrating Gaussian approximations versus actual distributions for an education attribute.

FIG. 5G-5I presents graphs illustrating Gaussian approximations versus actual distributions for an age attribute.

FIG. 6A presents a graph illustrating divergence between the Gaussian approximation and the actual distribution of each attribute.

FIG. 6B presents a graph illustrating information leakage for each type of attribute.

FIG. 6C presents a graph illustrating performance measurements for each of the four phases of the protocol performed by the aggregator.

FIG. 6D presents a graph illustrating relative revenue (per attribute) for each user and the aggregator.

FIG. 7 presents a block diagram illustrating an exemplary apparatus for privacy-preserving aggregation of data, in accordance with an embodiment.

FIG. 8 illustrates an exemplary computer system for running an aggregator, in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

Overview

Embodiments of the present invention solve the problem of aggregating and monetizing user data in a privacy-preserving way by using encrypted user attribute data to compute probability density functions as approximations of actual distributions. A probability density function of a continuous random variable is a function that describes the relative likelihood for the random variable to take on a given value. The solution involves extending the summing property of secure multiparty computation functions in order to compute probability density functions in a distributed and privacy-preserving way. Secure multiparty computation involves providing multiple parties with a protocol for jointly computing a function while keeping their inputs private.

This disclosure describes a privacy-preserving framework for aggregating user attribute data and monetizing the user data. The framework includes a protocol that is executed between users, a data aggregator, and a customer. Users contribute encrypted and differentially-private data to the aggregator which extracts a statistical model of the underlying data. Differentially-private means that the aggregates computed by the aggregator will not be significantly affected by whether or not a specific user contributes his or her profile data. Rather than sending only encrypted data generated from attribute values, users also send encrypted data generated from the square of the attribute values. This allows the aggregator to compute the mean and variance of probability distribution functions.

The data aggregator receives the encrypted user attribute data and can use Gaussian approximations to estimate probability density functions for the user attributes. These user attributes include, for example, age, education, or income. The aggregation and monetization techniques are privacy-preserving in that they do not reveal personal information to the aggregator, other users or third parties. Users only disclose an aggregate model of their profiles. This preserves data utility and provides user privacy.

The aggregator can also dynamically assess the value of data aggregates, using an information-theoretic measure to compute the amount of “valuable” information that it can sell to customers (e.g., advertisers). An information-theoretic measure can provide the divergence (e.g., entropic dissimilarity) between two probability distractions. The aggregator can use this metric to dynamically value user statistics according to their inherent amount of “valuable” information (e.g., sensitivity). For instance, aggregators can assess whether age statistics in a group of participants are more sensitive than income statistics. One can measure the sensitivity of different data attributes in terms of the amount of information they leak.

The aggregator may apply the information-theoretic Jensen-Shannon divergence to quantify the distance between the distribution for each data attribute and a distribution that does not reveal “interesting” or actionable information, such as the uniform distribution. The Jensen-Shannon divergence is a method of measuring the similarity between two probability distributions. The aggregator can discretize distributions to compute the relative distance between an estimated distribution of each attribute and the uniform distribution to rank the attributes according to increasing order of information leakage or “value” of the information. Attributes with distributions that are at a greater distance from the uniform distribution offer greater value to customers because there is more information leakage.

The inventors also developed a pricing scheme that dynamically sets the price for different data attributes according to the amount of information leakage. This is a novel scheme for dynamic pricing of different data attributes based on the amount of “interesting” information they provide, which represents a more realistic estimation of the value of different data attributes compared to fixed pricing schemes.

This disclosure also describes an exemplary privacy-preserving system for aggregation of smart meter data. Smart meters can measure electricity consumption levels (or consumption levels for other utilities) and send the data to a data aggregator. The data aggregator can generate aggregate values and monetize the data without access to the electricity consumption data of individual users.

The disclosed techniques do not depend on a third-party for differential privacy, incurs low computational overhead, and addresses linkability issues between contributions and users. To the best of the inventors' knowledge, the disclosed solution provides the first privacy-preserving aggregation scheme for personal data monetization. This disclosure also provides the first privacy-preserving comparative measure of information leakage of personal data attributes based on the model parameters of data distributions.

The inventors evaluated the privacy-preserving framework on a real, anonymized dataset of 100,000 users (obtained from the United States Census Bureau) with different types of attributes. The results show that the framework (i) provides accurate aggregates with as little as 100 participants, (ii) generates revenue for users and data aggregators depending on the number of contributing users and sensitivity of attributes, and (iii) has low computational overhead on user devices (e.g., 0.3 ms for each user, independently of the number of participants).

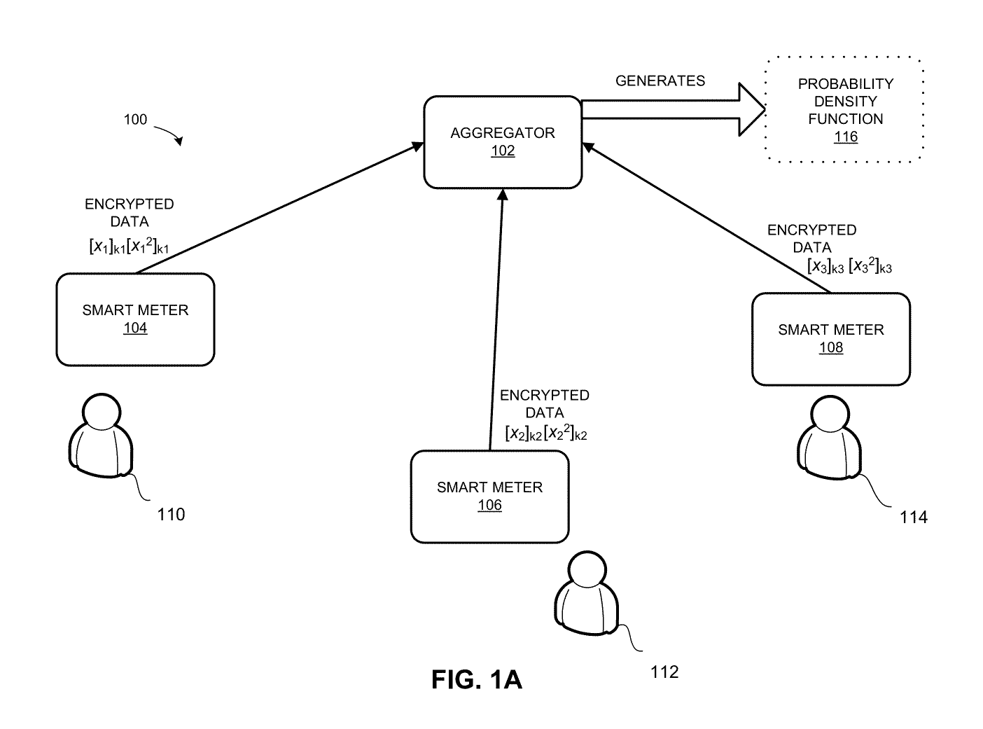

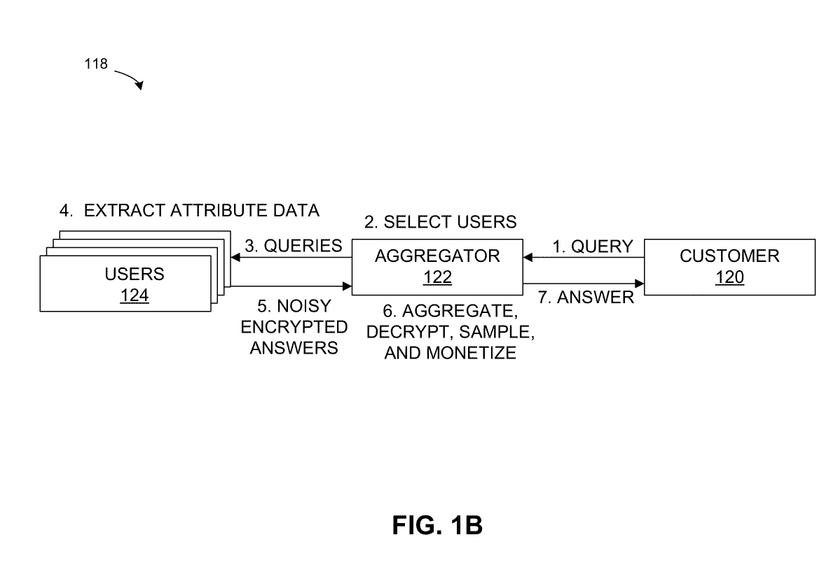

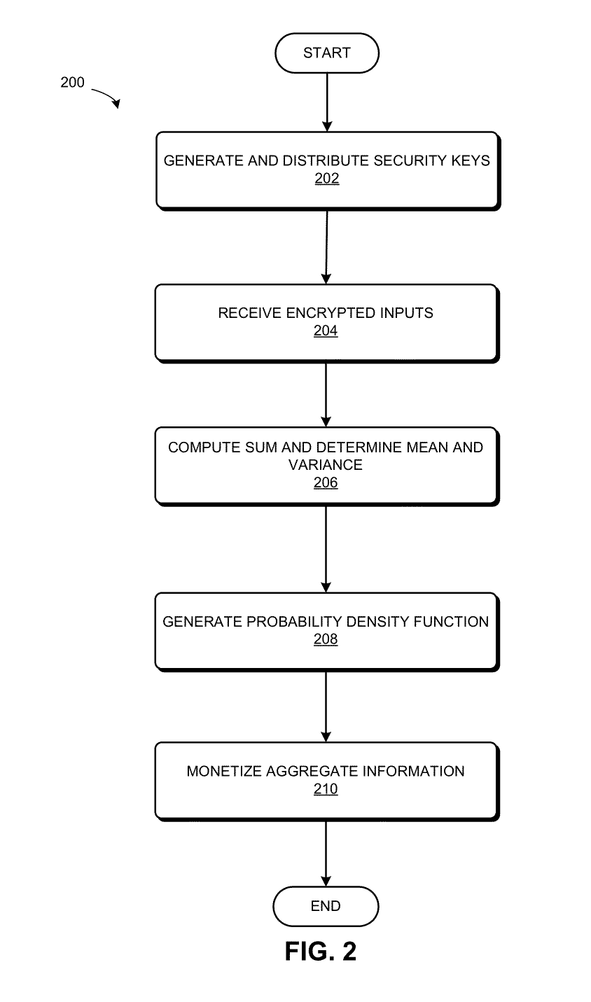

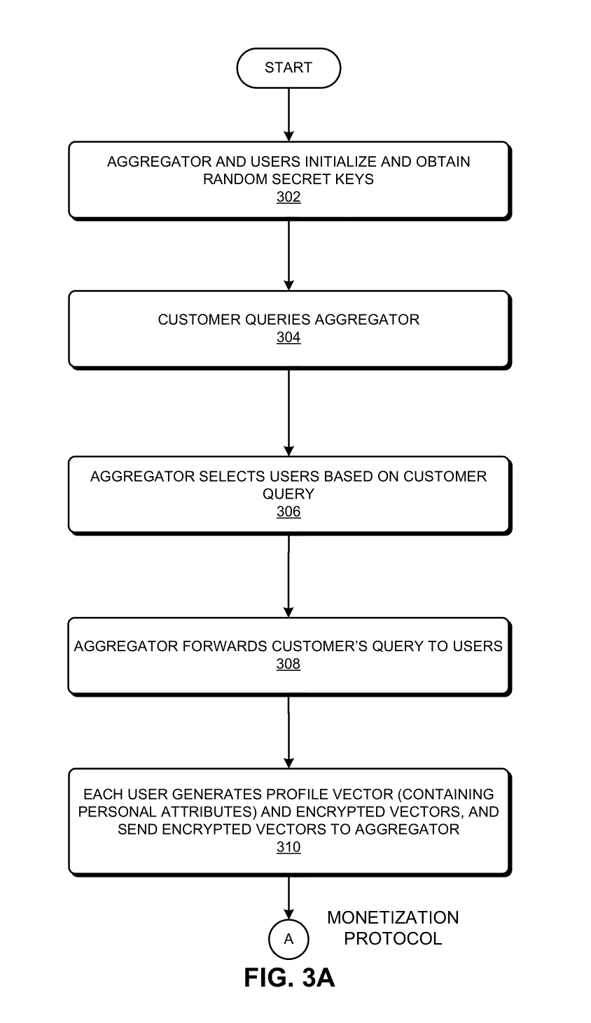

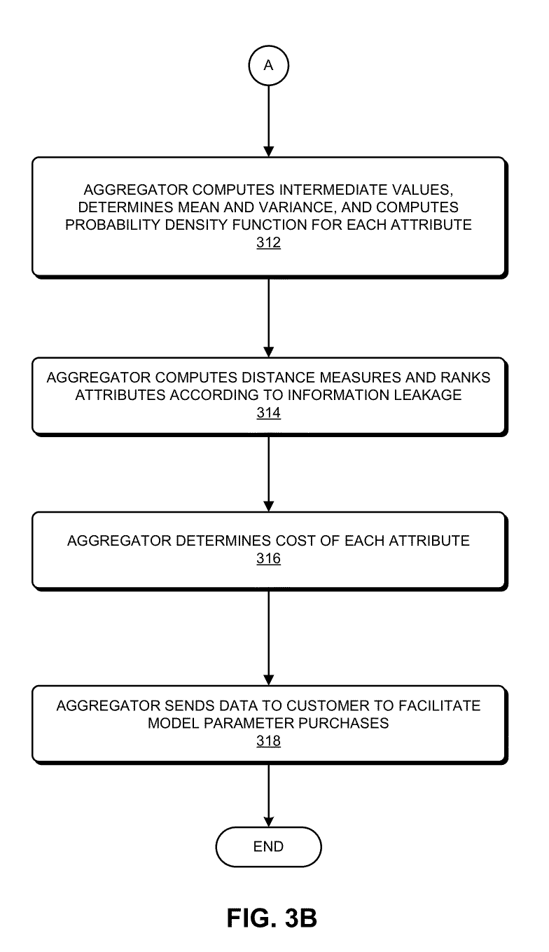

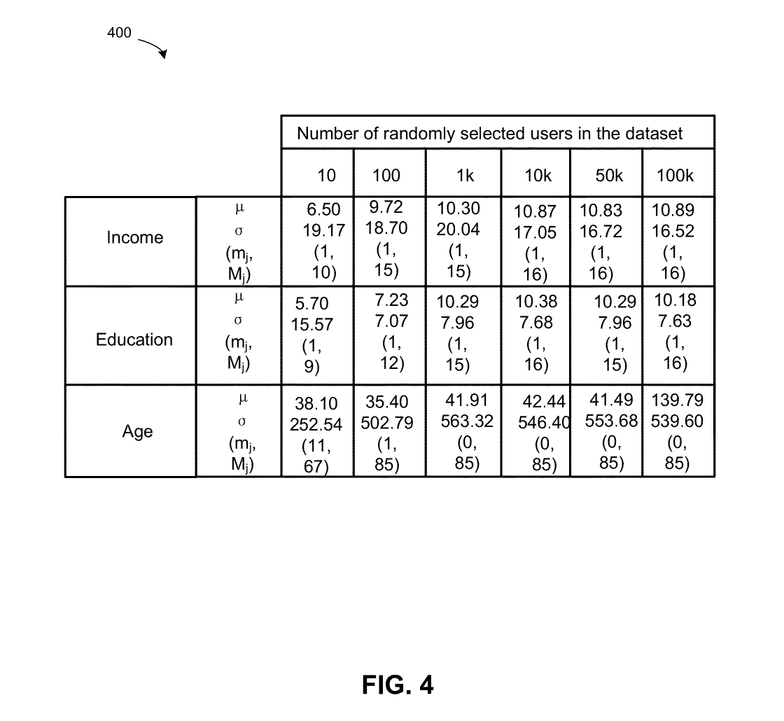

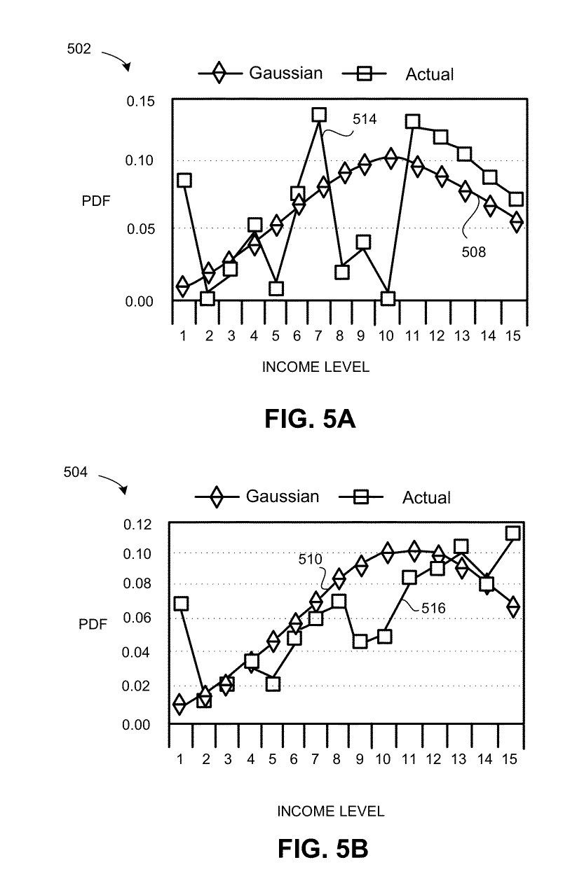

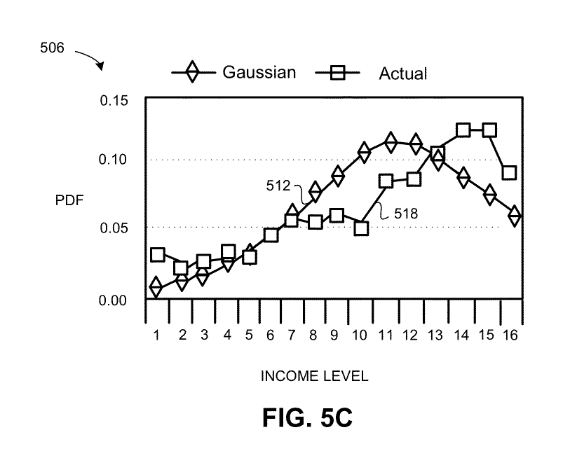

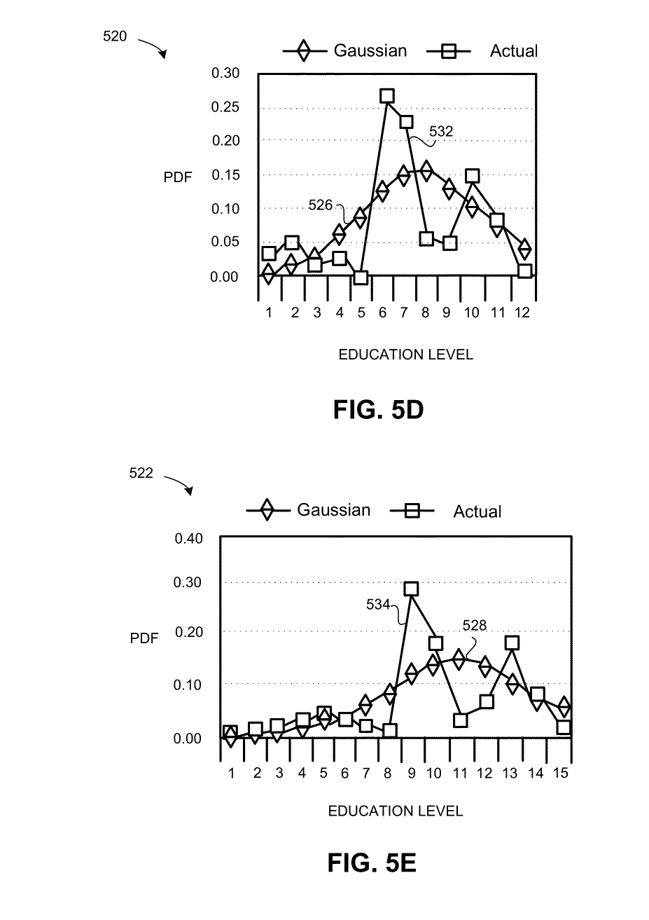

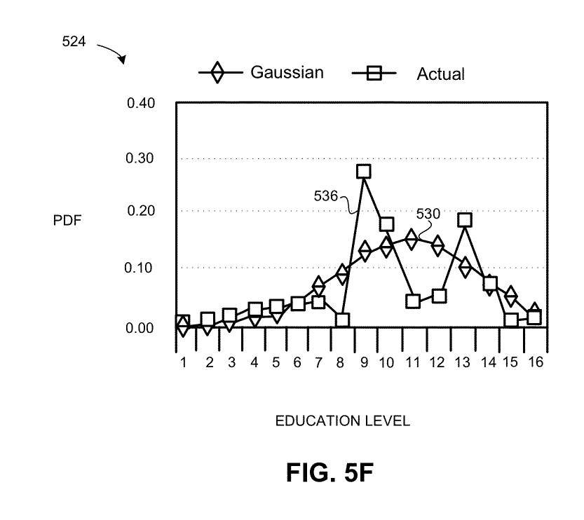

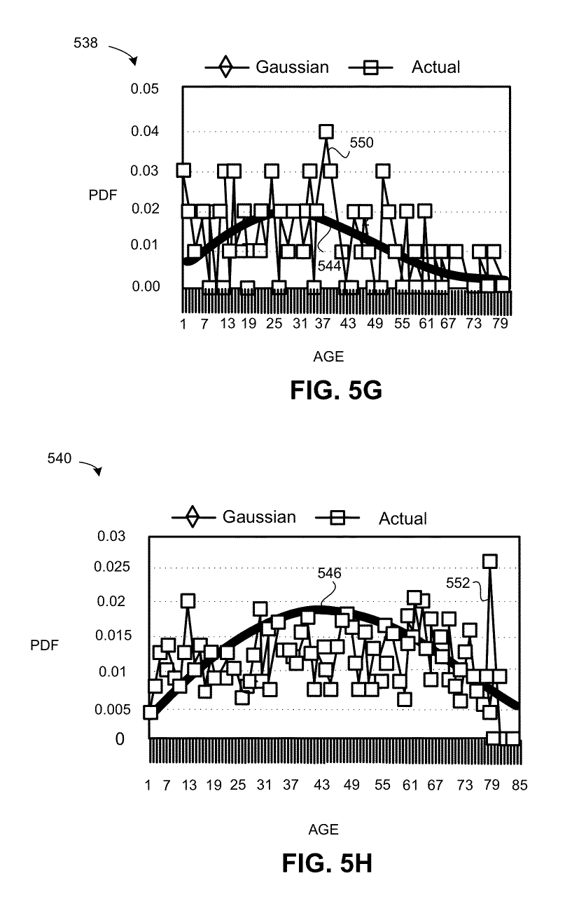

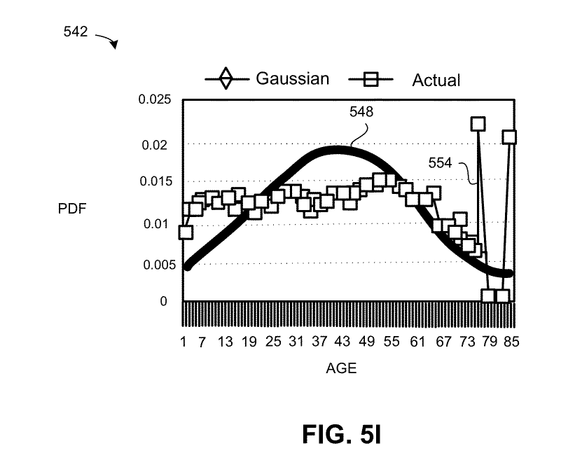

FIG. 1A illustrates a context of an exemplary privacy-preserving aggregation system that generates a probability density function for electricity consumption levels. FIG. 1B illustrates an exemplary system architecture of a privacy-preserving framework for aggregating and monetizing user data. FIG. 2 presents a flowchart illustrating an exemplary process for estimating a probability density function. FIG. 3A and FIG. 3B present a flowchart illustrating an exemplary privacy-preserving process for aggregating and monetizing user profile data. FIG. 4 presents a table illustrating a summary of a U.S. Census data set used for evaluation. FIG. 5A-5I present graphs illustrating Gaussian approximations versus actual distributions for income, education, and age attributes.

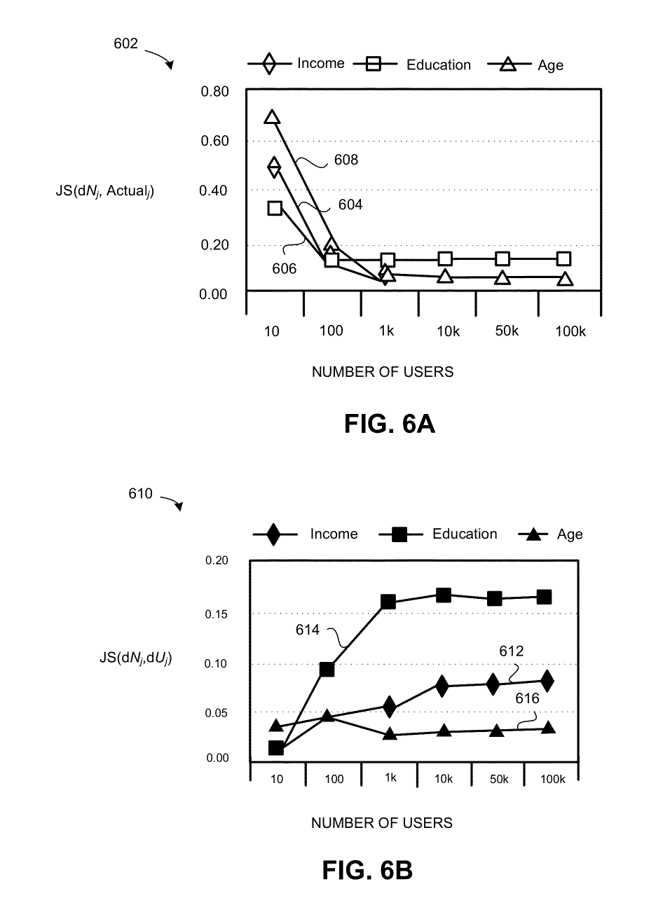

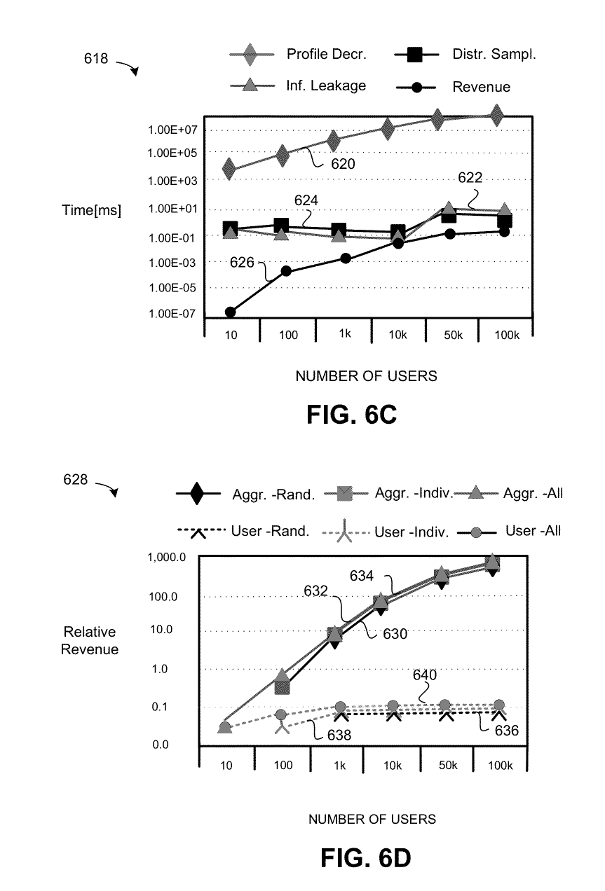

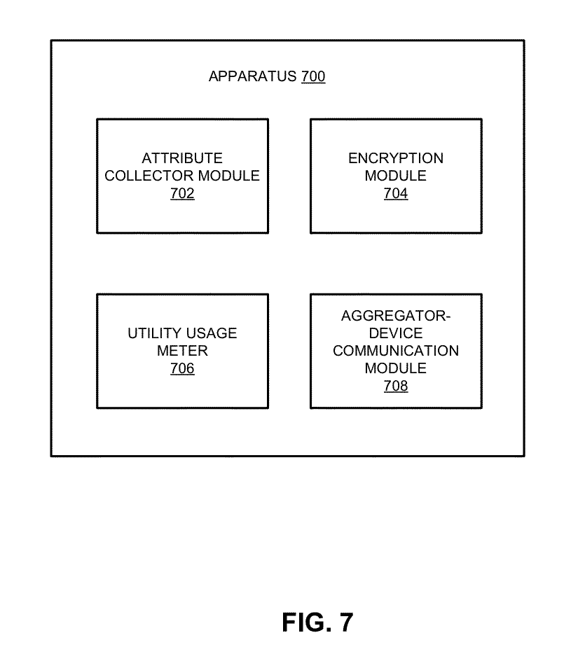

FIG. 6A presents a graph illustrating divergence between the Gaussian approximation and the actual distribution of each attribute. FIG. 6B presents a graph illustrating information leakage for each type of attribute. FIG. 6C presents a graph illustrating performance measurements for each of the four phases of the protocol performed by the aggregator. FIG. 6D presents a graph illustrating relative revenue (per attribute) for each user and the aggregator. FIG. 7 illustrates an exemplary computer system for running an aggregator, in accordance with an embodiment.

### System Architecture

FIG. 1A presents a block diagram illustrating an exemplary context of a privacy-preserving aggregation system 100, according to an embodiment. As illustrated in FIG. 1, system 100 includes an aggregator 102 and smart meters 104-108. Smart meters 104-108 may measure, for example, electricity consumption levels of users 110, 112, and 114, respectively.

Aggregator 102 receives encrypted data from smart meters 104-108 and generates a probability density function 116 using the encrypted data. Aggregator 102 may sell the probability density function 116 to a customer. Smart meter 104 sends data x₁ and x₁² encrypted using key k1: [x₁]ₖ₁ and [x₁²]ₖ₁ Smart meter 106 sends data x₂ and x₂² encrypted using key k2: [x₂]ₖ₂ and [x₂²]ₖ₂ Smart meter 108 sends data x₃ and x₃² encrypted using key k3: [x₃]ₖ₃ and [x₃²]ₖ₃.

Aggregator 102 can compute the mean using the sum of the encrypted values for N devices (brackets indicate encryption):

$$mean μ = \frac{1}{N} {\sum }_{i = 1}^{N} [ {x}_{i} ]$$

Aggregator 102 may also compute the variance using the encrypted square values:

$$variance {σ}^{2} = ( \frac{1}{N} {\sum }_{i = 1}^{N} [ {x}_{i}^{2} ] ) - {μ}^{2}$$

In some scenarios, users may be part of a group of people that agree to reveal encrypted versions of their personal data to advertisers. The advertisers do not receive each person's individual data. Instead, advertisers only have knowledge of the aggregate data for users. In exchange for the users' encrypted data, the users may get special discounts.

Note that in some implementations, users can also contribute additional values, such as x³ or x⁴ and higher order moments and aggregator 102 may combine them into higher order approximations using moment-generating functions. Moment-generating functions of a random variable X are an alternative specification of probability distribution based on moments. The expected value of k-th moments contributed by users is equal to the k-th moment of the population.

FIG. 1B presents a block diagram illustrating an exemplary system architecture of a privacy-preserving framework for aggregating and monetizing user data, according to an embodiment. As illustrated in FIG. 1B, system 118 includes three separate entities. These entities include a customer 120, a data aggregator 122 (hereinafter referred to simply as “aggregator 122”), and a set of N users 124. The set of N users may be represented as users U={1, . . . , N}.

Customer 120 is interested in buying aggregates of users' data. Customer 120 queries aggregator 122 for user information, while users 124 contribute their personal information to aggregator 122. Aggregator 122 acts as a proxy between users 124 and customer 120 by aggregating and monetizing user data. Users 124 contribute encrypted profiles to aggregator 122. Aggregator 122 combines encrypted profiles and determines model parameters (e.g., mean and variance) in cleartext, which it monetizes on behalf of users with potential customers. Below are detailed descriptions of the system model, including descriptions of users 124, aggregator 122, and the customer 120.

Users.

Users store a set of personal attributes such as age, gender, and preferences locally. Users may want to monetize their personal information. Each user iεU maintains a profile vector pᵢ=[x_{i,1}, . . . , x_{i,K}], where x_{i,j}εD is the value of attribute j of user i and D is a suitable domain for j. For example, if j represents the age of user i, then x_{i,j}Σ{1, . . . , Mⱼ}, Mⱼ=120, and D⊂N.

In practice, users can generate their personal profiles manually, or leverage profiles maintained by third parties. Several social networks notably allow subscribers to download their online profile. A Facebook profile, for example, contains numerous personally identifiable information items (such as age, gender, relationships, location), preferences (movies, music, books, tv shows, brands), media (photos and videos) and social interaction data (list of friends, wall posts, liked items).

Each user i can specify a privacy-sensitivity value 0≦λ_{i,j}≦1 for each attribute j. Large values of λ_{i,j} indicate high privacy sensitivity or lower willingness to disclose. In practice, λ_{i,j} can assume a limited number of discrete values, which could represent the different levels of sensitivity according to Westin's Privacy Indexes.

Users may want to monetize their profiles while preserving their privacy. For instance, users may be willing to trade an aggregate of their online behavior, such as the frequency at which they visit different categories of websites, rather than the exact time and URLs. Also, users are associated with devices that can perform cryptographic operations including multiplication, exponentiation, and discrete logarithm.

Data Aggregator.

Aggregator 122 is an untrusted third-party that performs the following actions: (1) it collects encrypted attributes from users, (2) it aggregates contributed attributes in a privacy-preserving way, and (3) it monetizes users' aggregates according to the amount of “valuable” information that each attribute conveys.

Users and aggregator 122 may sign an agreement upon user registration that authorizes aggregator 122 to access only the aggregated results (but not users' actual attributes), to monetize them with customers, and to take a share of the revenue from the sale. It also binds aggregator 122 to redistribute the rest of the revenue among contributing users.

Customer.

Customer 120 wants to obtain aggregate information about users and is willing to pay for it. Customer 120 can have commercial contracts with multiple data aggregators. Similarly, aggregator 122 can have contracts with multiple customers. Note that although this disclosure describes a system with one customer and one aggregator, different implementations may include any number of customers and/or aggregators. Customer 120 interacts with aggregator 122 but not directly with users. Customer 120 obtains available attributes, and may initiate an aggregation by querying aggregator 122 for specific attributes.

FIG. 1B also illustrates a simplified overview of the operations performed by customer 120, aggregator 122, and users 124. Customer 120 may send a query to aggregator 122, which selects the users and queries the users. Users 124 extract attribute data and send noisy encrypted answers to aggregator 122. Aggregator 122 may then aggregate the attribute data, decrypt the aggregates, perform distribution sampling, and monetize the aggregate data. Aggregator 122 subsequently send answers to customer 120. These operations are described in greater detail with respect to FIG. 3A and FIG. 3B.

### Applications

The proposed system model is well-suited to many real-world scenarios, including market research and online tracking use cases. For instance, consider a car dealer that wants to assess user preferences for car brands, their demographics, and income distributions. A data aggregator might collect aggregate information about a representative set of users and monetize it with the car dealer. Companies such as Acxiom currently provide this service, but raise privacy concerns. The solution disclosed herein enables such companies to collect aggregates of personal data instead of actual values and reward users for their participation.

Another example is that of an online publisher (e.g., a news website) that wishes to know more about its online readers. In this case, the aggregator is an online advertiser that collects information about online users and monetizes it with online publishers. Similarly, one can measure the opinion of TV show audiences, target an advertisement for the highest topic of interest among a crowd, and monetize probability distribution functions to provide others with an understanding of local user preferences.

Finally, the proposed model can also be appealing to data aggregators in healthcare. Healthcare data is often fragmented in silos across different organizations and/or individuals. A healthcare aggregator can compile data from various sources and allow third parties to buy access to the data. At the same time, data contributors (e.g., users) receive a fraction of the revenue. The techniques disclosed herein thwarts privacy concerns and helps with the pricing of contributed data.

### Threat Model

In modeling security, one may consider both passive and active adversaries.

Passive Adversaries.

Semi-honest (or honest-but-curious) passive adversaries monitor user communications and try to infer the individual contributions made by other users. For instance, users may wish to obtain attribute values of other users; similarly, data aggregators and customers may try to learn the values of the attributes from aggregated results. A passive adversary executes the protocol correctly and in the correct order, without interfering with inputs or manipulating the final result.

Active Adversaries.

Active (or malicious) adversaries can deviate from the intended execution of the protocol by inserting, modifying or erasing input or output data. For instance, a subset of malicious users may collude with each other in order to obtain information about other (honest) users or to bias the result of the aggregation. To achieve their goal, malicious users may also collude with either the data aggregator or with the customer. Moreover, a malicious data aggregator may collude with a customer in order to obtain private information about the user attributes.

FIG. 2 presents a flowchart illustrating an exemplary process for estimating a probability density function, according to an embodiment. FIG. 2 illustrates one possible implementation, and specific details may vary according to implementation. FIG. 2 illustrates an overview of a process performed by a data aggregator for an implementation similar to that illustrated in FIG. 1A (e.g., involving aggregating smart meter data). FIG. 3A and FIG. 3B illustrate a process associated with a protocol for an implementation similar to that illustrated in FIG. 1B (e.g., involving aggregating user attributes). Note that some implementations may incorporate operational details from either the description of FIG. 2 or the description of FIG. 3A and FIG. 3B. Aggregator 102 from FIG. 1A may perform the operations illustrated in FIG. 2.

During operation, aggregator 102 may initially generate and distribute security keys to multiple devices, such as the smart meters depicted in FIG. 1A (operation 202). Aggregator 102 may generate a different security key for each device. In some implementations, aggregator 102 may generate security keys for the plurality of devices after receiving user agreement that aggregator 102 will receive encrypted versions of the users' data from the users' devices. With these agreements, aggregator 102 should not receive any plaintext data. The users need not be concerned about revealing their individual data. The encrypted inputs may be received from users' devices in exchange for a benefit of economic value. This may be part of a monetizing and/or other advertising program. Users can benefit from revealing their personal data without allowing advertisers to know each user's actual individual data.

Aggregator 102 may receive encrypted input data from the multiple devices (operation 204). There may be hundreds of such devices or more. The devices may use the security keys to encrypt data. For example, the smart meters may measure and encrypt any type of data. Such data may represent consumption levels for utilities such as electricity or water.

Aggregator 102 may then compute a sum of the encrypted data and an average of the encrypted data, and determine a mean and variance of a probability density function (operation 206). Note that aggregator 102 may compute the mean and variance for different types of data. For example, aggregator 102 may compute the average consumption of electricity in a city without knowledge of each individual's consumption levels, and then determine the mean and variance of a probability density function for the level of electricity consumption. The details for computing mean and variance from encrypted data are described with respect to FIG. 3A and FIG. 3B.

Aggregator 102 may generate a probability density function (operation 208). In some implementations, aggregator 102 may generate the probability density function of a Gaussian distribution. Aggregator 102 may generate many different probability density functions for different types of data. In some implementations, aggregator 122 may also rank the probability density functions according to information leakage. Details for generating and ranking the probability density functions are also described with respect to FIG. 3A and FIG. 3B.

Subsequently, aggregator 102 monetizes the aggregate information (operation 210). Aggregate 102 may sell the aggregate information to customers. These customers may have a contractual agreement to pay for access to the probability density functions. In some implementations, system 100 may allow a third party to access the information through an application programming interface (API). Neither the aggregator 102 nor third parties have access to original, unencrypted data for individual users, thereby protecting the privacy of the users.

The sections below describe functions and primitives for the aggregation and monetization of user attribute data, including computing aggregates by estimating the probability density function of user attributes. Note that the inventors decided to use the Gaussian approximation to estimate probability density functions for two reasons. First, this leads to precise aggregates with few users. The central limit theorem states that the arithmetic mean of a sufficiently large number of independent random variables, drawn from distributions of expected value μ and variance σ², will be approximately normally distributed N(μ, σ²). Second, the Gaussian probability density function is fully defined by these two parameters and thus there is no need for additional coordination among users (after an initialization phase). For information leakage ranking, the inventors chose an information-theoretic distance function.

### Exemplary Protocol for Monetizing Personal Attributes

FIG. 3A and FIG. 3B present a flowchart illustrating an exemplary privacy-preserving process for aggregating and monetizing user profile data, according to an embodiment. The illustrated process forms part of a protocol in which users can trade their personal attributes in a privacy-preserving way, potentially in exchange for monetary retributions.

With this protocol, there are two possible modes of implementations: batch and interactive. In batch mode, users 124 send their encrypted profiles containing personal attributes to aggregator 122. Aggregator 122 combines encrypted profiles, decrypts them, obtains aggregates for each attribute, and ranks attributes based on the amount of “valuable” information they provide. Aggregator 122 then offers customer 120 access to specific attributes.

In interactive mode, customer 120 initiates a query about specific attributes and users. Aggregator 122 selects the users matching the query, collects encrypted replies, computes aggregates, and monetizes them according to a pricing function. FIG. 3A and FIG. 3B illustrates operations for an implementation of the interactive mode, although specific details may vary according to implementation.

This protocol is executed between users 124, aggregator 122, and customer 120. Each user iεU and aggregator 122 may receive the following parameters: The total number of users N, the total number of attributes K, the maximum value Mⱼ and minimum value mⱼ for each attribute j, and a time period t (e.g., last month) for which users agree to aggregate their data.

As illustrated in FIG. 3A, aggregator 122 and users 124 may engage in a secure key establishment protocol to obtain individual random secret keys sᵢ (operation 302). Note that s₀ is only known to aggregator 122, and sᵢ (∀iεU) is only known to user i, such that s₀+s₁+ . . . +s_{N}=0 (this condition is required for the aggregation of data for various implementations). Different implementations may use any secure key establishment protocol or trusted dealer in this phase to distribute the secure keys, as long as the condition on their sum is respected.

In one implementation, G is a cyclic group of prime order n, where the decisional Diffie-Hellman assumption holds. H:Z→G is a hash function modeled as a random oracle. Assume that a trusted dealer chooses a generator gεG, which is public, and N+1 random secret shares s₀, s₁, . . . , s_{N} εZₚ such that Σᵢ₌₀^{N}sᵢ=0. Aggregator 122 obtains the secret s₀ and each user iεU obtains a respective secret sᵢ.

Customer 120 begins by sending a query to aggregator 122 (operation 304). The query may contain information about the type of aggregates and users. In some implementations, the query may be formatted as an SQL query. Aggregator 122 then selects users based on the customer query (operation 306). Aggregator 122 may select users based on some basic information, such as user demographics. In some implementations, aggregator 122 may let users decide whether to participate or not when it forwards the customer query to users.

Aggregator 122 forwards the customer's query to users (operation 308). Aggregator 122 may also send to users a public feature extraction function ƒ.

Next, each user i generates a profile vector containing personal attributes and also generates encrypted vectors (operation 310). Each user i generates a profile vector pᵢ εD^{K} containing personal attributes jε{1, . . . , K}. K is the number of attributes and the number of dimensions of the profile vector, and D represents the domain. In other words, each user i generates a profile vector pᵢ=[x_{i,1}, . . . , x_{i,K}]. Each attribute j is a value x_{i,j}ε{mₙ, . . . , Mⱼ}, where mⱼ, MⱼεZₚ are the minimum and the maximum value. Note that computations are in cyclic group Zₚ, and p is a prime order. In some implementations, p is a 1024 bits modulus. In practice, a user can derive pᵢ either from an existing online profile (e.g., Facebook or Google+) or by manually entering values x_{i,j}. The inventors used real values obtained from the U.S. Census Bureau for evaluation.

To privately compute the Gaussian parameters (\hat{μ}ⱼ, σⱼ²) for each attribute j and guarantee (ε, δ)-differential privacy, each user i adds noise values r_{i,j}, o_{i,j}, to attribute values sampled from a symmetric Geometric distribution. In particular, each user i adds noise to both x_{i,j} and x_{i,j}², as they will be subsequently combined to obliviously compute the parameters of the model that underlies the actual data:

\hat{x}_{i,j}=x_{i,j}+r_{i,j} mod p

\hat{x}_{i,j}⁽²⁾=x_{i,j}²+o_{i,j} mod p

where p is the prime order.

With \hat{x}_{i,j} and \hat{x}_{i,j}⁽²⁾ each user generates the following encrypted vectors (cᵢ, bᵢ):

$${c}_{i} = ( \begin{matrix}{c}_{i , 1} \\ {c}_{i , 2} \\ ⋮ \\ {c}_{i , K}\end{matrix} ) = ( \begin{matrix}{g}^{{\hat{x}}_{i , 1}} {H ( t )}^{{s}_{i}} \\ {g}^{{\hat{x}}_{i , 2}} {H ( t )}^{{s}_{i}} \\ ⋮ \\ {g}^{{\hat{x}}_{i , K}} {H ( t )}^{{s}_{i}}\end{matrix} )$$

$${b}_{i} = ( \begin{matrix}{b}_{i , 1} \\ {b}_{i , 2} \\ ⋮ \\ {b}_{i , K}\end{matrix} ) = ( \begin{matrix}{g}^{{\hat{x}}_{i , 1}^{( 1 )}} {H ( t )}^{{s}_{i}} \\ {g}^{{\hat{x}}_{i , 2}^{( 2 )}} {H ( t )}^{{s}_{i}} \\ ⋮ \\ {g}^{{\hat{x}}_{i , K}^{( 2 )}} {H ( t )}^{{s}_{i}}\end{matrix} )$$

Note that b_{i,j} and c_{i,j} represent the encrypted data of each user i for an attribute j in a group of N users, sᵢ represents the secret key for user i, g represents the generator, K represents the number of attributes, and H(t) represents a hash function at time t.

Each user i then sends (cᵢ, bᵢ) to aggregator 122. Note that the encryption scheme guarantees that aggregator 122 is unable to decrypt the vectors (cᵢ, bᵢ). However, aggregator 122 can decrypt aggregates using secret share s₀.

Aggregator 122 then computes intermediate values, determines mean and variance, and computes probability density function for each attribute (operation 312). To compute the sample mean \hat{μ}ⱼ and variance \hat{σ}ⱼ² without having access to the individual values \hat{x}_{i,j}, \hat{x}_{i,j}⁽²⁾ of any user i, aggregator 122 first computes the intermediate values:

$${V}_{j} = {H ( t )}^{{s}_{0}} {\prod }_{i = 1}^{N} {c}_{i , j} = {H ( t )}^{{\sum }_{k = 0}^{N} {s}_{k}} {g}^{{\sum }_{i = 1}^{N} {\hat{x}}_{i , j}} = {g}^{{\sum }_{i = 1}^{N} {\hat{x}}_{i , j}}$$

$${W}_{j} = {H ( t )}^{{s}_{0}} {\prod }_{i = 1}^{N} {b}_{i , j} = {H ( t )}^{{\sum }_{k = 0}^{N} {s}_{k}} {g}^{{\sum }_{i = 1}^{N} {\hat{x}}_{i , j}^{( 2 )}} = {g}^{{\sum }_{i = 1}^{N} {\hat{x}}_{i , j}^{( 2 )}}$$

Specifically, b_{i,j} and c_{i,j} represent the encrypted data of each user i for an attribute j in a group of N users, s₀ represents the secret key for aggregator 122, and H(t) represents a hash function at time t. Also, sₖ represents the secret key for user k, and g represents the generator.

To obtain (\hat{μ}ⱼ, \hat{σ}ⱼ²), aggregator 122 computes the discrete logarithm base g of {Vⱼ, Wⱼ}:

$${\hat{μ}}_{j} = \frac{{log}_{g} ( {V}_{j} )}{N} = \frac{{\sum }_{i = 1}^{N} {\hat{x}}_{i , j}}{N}$$

$${\hat{σ}}_{j}^{2} = \frac{{log}_{g} ( {W}_{j} )}{N} - {\hat{μ}}_{j}^{2} = \frac{{\sum }_{i = 1}^{N} {\hat{x}}_{i , j}^{( 2 )}}{N} - {\hat{μ}}_{j}^{2}$$

Finally, using the derived (\hat{μ}ⱼ, \hat{σ}ⱼ²), aggregator 122 computes the Gaussian probability density function for each of the K attributes. In some implementations, aggregator 122 may compute probability density functions at different points in time. Users can contribute information regularly and one can observe trends and patterns in attitudes of the users.

Aggregator 122 may then compute distance measures and rank attributes according to information leakage (operation 314). In order to estimate the amount of valuable information (i.e., sensitivity) that each attribute leaks, the inventors propose to measure the distance between Nⱼ and the Uniform distribution U (that does not leak any information). Nⱼ represents the estimated distribution for attribute j. Others have studied a related concept for measuring the “interestingness” of textual data by comparing it to an expected model, usually with the Kullback-Liebler divergence. To the best of the inventors' knowledge, this disclosure is the first to explore this approach in the context of information privacy. Instead of the KL divergence, the inventors rely on the Jensen-Shannon (JS) divergence for two reasons: (1) JS is a symmetric and (2) bounded equivalent of the KL divergence. It is defined as:

$$\begin{matrix}JS ( μ , q ) = \frac{1}{2} KL ( u , m ) + \frac{1}{2} KL ( q , m ) \\ = H ( \frac{1}{2} u + \frac{1}{2} q ) - \frac{1}{2} H ( u ) - \frac{1}{2} H ( q )\end{matrix}$$

where m=u/2+q/2 and H is the Shannon entropy. As JS is in [0,1] (when using the logarithm base 2), it quantifies the relative distance between Nⱼ and Uⱼ, and also provides absolute comparisons with distributions different from the uniform.

Note that in some implementations, one can also compare Nⱼ with a Gaussian distribution or other probability distribution. Some implementations may use different similarity functions for measuring divergence, such as the Kullback-Liebler Divergence, based on specific requirements (e.g., presence or absence of bounds, symmetry, performance, or data types).

Since JS operates on discrete values, aggregator 122 must first discretize distributions Nⱼ and Uⱼ. Given the knowledge of intervals {mᵢ, . . . , Mⱼ} for each attribute j, one can use Riemann's centered sum to approximate a definite integral, where the number of approximation bins is related to the accuracy of the approximation. The inventors choose the number of bins to be Mⱼ-mⱼ, and thus guarantee a bin width of 1. One can approximate Nⱼ by the discrete random variable dNⱼ with the following mass function:

$$Pr ( d {N}_{j} ) = ( \begin{matrix}Pr ( {x}_{j} = {m}_{j} ) \\ Pr ( {x}_{j} = {m}_{j} + 1 ) \\ ⋮ \\ Pr ( {x}_{j} = {M}_{j} )\end{matrix} ) = ( \begin{matrix}{pdf}_{j} ( \frac{1}{2} ( {m}_{j} + {m}_{j} - 1 ) ) \\ {pdf}_{j} ( \frac{1}{2} ( {m}_{j} + 1 + {m}_{j} ) ) \\ ⋮ \\ {pdf}_{j} ( \frac{1}{2} ( {M}_{j} + {M}_{j} - 1 ) )\end{matrix} )$$

where pdfⱼ is the probability density function of Nⱼ and xⱼε{mⱼ, . . . , Mⱼ}l. For the uniform distribution Uₚ the discretization to d Uj is straightforward, i.e., Pr(dUⱼ)=(1/(Mⱼ−mⱼ), . . . , 1/(Mⱼ−mⱼ))^{T}, where dim(dUⱼ)=K.

In one implementation, aggregator 122 can compute distances dⱼ=JS(dNⱼ, dUⱼ)ε[0,1] and rank attributes in increasing order of information leakage such that d_{ρ1}≦d_{ρ2}≦ . . . ≦d_{ρK}, where

ρᵢ=arg minⱼ dⱼ and ρ_{z} (for 2≦z≦K) is defined as

$${ρ}_{z} = arg {min}_{j \neq {\{ {ρ}_{k} \}}_{k = 1}^{z - 1}} ( {d}_{j} ) .$$

At this point, aggregator 122 has computed the 3-tuple (d_{ρj}, \hat{μ}ⱼ, \hat{σ}ⱼ²) for each attribute j. Each user i can now decide whether it is comfortable sharing attribute j given distance dⱼ and privacy sensitivity λ_{i,j}. To do so, each user i sends λ_{i,j} to aggregator 122 for comparison. Aggregator 122 then checks which users are willing to share each attribute j and updates a ratio Yⱼ=Sⱼ/N where Sⱼ is the number of users that are comfortable sharing, i.e., Sⱼ=|{iεU s.t.dⱼ≦1−λ_{i,j}}|. In some implementations, aggregator 122 may use a majority rule to decide whether or not to monetize attribute j.

In some implementations, aggregator 122 may re-compute aggregate values using only data from those users that are willing to share their attribute data, and share the re-computed aggregate values. In some implementations, aggregator 122 may send information including distance dⱼ to users, and users may choose to share their attribute data provided that they receive a predetermined increase in monetary retribution.

Note that one can use the disclosed techniques for ranking data aggregates in many scenarios, including: (1) detecting sensitivity of different data types for a set of users, (2) pricing different data types depending on potential economic value, (3) quantifying similarities of distributions among different information types, (4) assessing similarity between the expected behavior of a person and the actual behavior for authorization and access control purposes, (5) diagnosing a health condition (comparison of the symptoms with expected model for a given condition), and (6) providing differentiated privacy guarantees (and costs) based on the sensitivity of information. This can help existing market players introduce differentiated services and pricing based on the sensitivity of information types, depending on the set of users.

Further, the disclosed method for privacy-preserving ranking of user data is oblivious to the nature or type of personal information it ranks, as it does not require access to data. It works with any number of users, and operates with any type of data that can be expressed in numerical form.

### Pricing of User Attributes

After the ranking phase, aggregator 122 may conclude the process with pricing and revenue phases. Aggregator 122 may determine the cost Cost(j) of each attribute j (operation 316). Note that users typically assign unique monetary value to different types of attributes depending on several factors, such as offline/online activities, type of third-parties involved, privacy sensitivity, and amount of details and fairness.

In some applications, aggregator 122 can measure the value of aggregates depending on their sensitivity, the number of contributing users, and the price of each attribute. One possible way to estimate the value of an aggregate j is to use the following linear model:

Cost(j)=Price(j)˜dⱼ·N

where Price(j) is the monetary value that users assign to attribute j. As an example pricing scheme each attribute may have a relative value of 1. Others have estimated the value of user attributes in a large range from $0.0005 to $33, highlighting the difficulty in determining a fixed price. In practice, this is likely to change depending on the monetization scenario.

Aggregator 122 may then send data to customers to facilitate purchases of model parameters (operation 318). In some implementations, aggregator 122 may send a set of 2-tuples {(d_{ρz}, Cost(ρ_{z}))}_{ρ=1}^{K} to customer 120. Based on the tuples, customer 120 may select a set P of attributes it wishes to purchase. After the purchase is complete, aggregator 122 re-distributes revenue R among users and itself, according to an agreement stipulated with the users upon their first registration with aggregator 122.

One implementation of a revenue sharing monetization scheme in which revenue is split among users and aggregator 122 (e.g., aggregator 122 takes commissions) can be as follows:

$$R ( A ) = {\sum }_{j ∈ P}^{ } {w}_{j} \cdot Cost ( j ) , \\ R ( i ) = \frac{1}{N} {\sum }_{j ∈ P}^{ } ( 1 - {w}_{j} ) \cdot Cost ( j ) , ∀ i ∈ U$$

where i represents a user i, j indicates attribute j, N represents the number of users, A represents aggregator 122 and wⱼ is the commission percentage of aggregator 122. This system is popular in various aggregating schemes, credit-card payments, and online stores (e.g., iOS App Store). Note that this assumes that wⱼ is fixed for each attribute j.

In some implementations, aggregator may receive the data (e.g., encrypted vectors with user attribute data) from users with devices in exchange for a benefit of economic value to the users as part of a monetizing and/or advertising or marketing program. For example, the users may get special discounts based on personal car preferences and personal brand preferences or other customized offers. In return, advertisers may receive aggregate data such as distributions of attributes.

### Evaluation

To test the relevance and the practicality of the privacy-preserving monetization solution, the inventors measure the quality of aggregates, the overhead, and generated revenue. In particular, the inventors study how the number of protocol participants and their privacy sensitivities affect the accuracy of the Gaussian approximations, the computational performance, the amount of information leaked for each attribute, and revenue.

The inventors analyzed an implementation with secret shares in Zₚ where p is a 1024 bits modulus, with number of users Nε[10, 100000], and each user i is associated with profile pᵢ. The inventors implemented the privacy-preserving protocol in Java, and relied on public libraries for secret key initialization, for multi-threading decryption, and on the MAchine Learning for LanguagE Toolkit (MALLET) package for computation of the JS divergence.

The inventors ran the experiments on a machine equipped with Mac OSX 10.8.3, dual-core Core i5 processor, 2.53 GHz, and 8 GB RAM. Measurements up to 100 users are averaged over 300 iterations, and the rest (from 1 k to 100 k users) are averaged over 3 iterations due to large simulation times.

The inventors populated user profiles with U.S. Census Bureau information. The inventors obtained anonymized offline and online attributes for 100,000 people, and pre-processed the acquired data by removing incomplete profiles (i.e., some respondents preferred not to reveal specific attributes).

The inventors focused on three types of offline attributes: yearly income level, education level, and age. The inventors selected these attributes because (1) a recent study shows that these attributes have high monetary value (and thus privacy sensitivity), and (2) they have significantly different distributions across users. This allowed the inventors to compare retribution models, and measure the accuracy of the Gaussian approximation for a variety of distributions.

FIG. 4 presents a table 400 illustrating a summary of a U.S. Census dataset used for evaluation. FIG. 4 shows the mean and standard deviation for the three considered attributes with a varying number of users. Note that the provided values for income and education use a specific scale defined by the Census Bureau. For example, a value of 1 and 16 for education correspond to “Less than 1st grade” and “Doctorate,” respectively. One may consider other types of attributes as well, such as internet, music and video preferences from alternative sources, such as Yahoo Webscope.

### Results

FIG. 5A-5C presents graphs 502, 504, 506 illustrating Gaussian approximations 508, 510, 512 versus actual distributions 514, 516, 518 for an income attribute. FIG. 5D-5F presents graphs 520, 522, 524 illustrating Gaussian approximations 526, 528, 530 versus actual distributions 532, 534, 536 for an education attribute. FIG. 5G-5I presents graphs 538, 540, 542 illustrating Gaussian approximations 544, 546, 548 versus actual distributions 550, 552, 554 for an age attribute.

FIG. 6A presents a graph 602 illustrating divergence between a Gaussian approximation and an actual distribution of each attribute. This is computed as JS(dNⱼ, Actualⱼ) for each attribute j. Lower values indicate better accuracy. Graph 602 includes lines 604, 606, 608 illustrating divergence for income, education, and age, respectively.

FIG. 6B presents a graph 610 illustrating information leakage for each type of attribute. The information leakage for the attributes (e.g., income, education, and age) is defined as JS(dNⱼ, dUⱼ). Lower values indicate smaller information leaks. Graph 610 includes lines 612, 614, 616 illustrating information leakage for income, education, and age, respectively.

FIG. 6C presents a graph 618 illustrating performance measurements for each of the four phases of the protocol performed by aggregator 122. Graph 618 includes lines 620, 622, 624, 626 illustrating performance measurements for profile decryption, information leakage, distribution sampling, and revenue respectively.

FIG. 6D presents a graph 628 illustrating relative revenue (per attribute) for each user iεU and aggregator 122, assuming that an attribute is valued at 1. Graph 628 includes lines 630, 632, 634, 636, 638, 640 illustrating revenue for aggregator and users when different sets of users contribute data to the aggregator. “Aggr.-Rand” displays revenue for the aggregator when a subset of all users are chosen at random to contribute data to the aggregator. “Aggr. Indiv.” displays revenue for the aggregator when only users that have privacy sensitivity greater than the data sensitivity contribute data to the aggregator. “Aggr.-All” displays revenue for the aggregator when all users contribute data to the aggregator.

“User-Rand” displays revenue for each user when a subset of all users are chosen at random to contribute data to the aggregator. “User Indiv.” displays revenue for each user when only users that have privacy sensitivity greater than the data sensitivity contribute data to the aggregator. “User-All” displays revenue for each user when all users contribute data to the aggregator.

The inventors evaluated four aspects of the privacy-preserving scheme: model accuracy, information leakage, overhead and pricing. The results of evaluating these four aspects are described below.

Model Accuracy.

The inventors proposed to approximate empirical probability density functions with Gaussian distributions. The accuracy of approximations is important to assess the relevance of derived data models. FIG. 5A-FIG. 5I illustrates comparisons between the actual distribution of each attribute with their respective Gaussian approximation and varies the number of users from 100 to 100,000. Note that in order to compare probabilities over the domain [mⱼ, Mⱼ], both the actual distribution and the Gaussian approximation are scaled such that their respective sums over that domain are equal to one. Observe that, visually, the Gaussian approximation captures general trends in the actual data.

One can measure the accuracy of the Gaussian approximation in more detail with the JS divergence (FIG. 6A). Observe that with 100 users, the approximation reaches a plateau for education, whereas income and age require 1 k users to converge. For the two latter attributes, the approximation accuracy triples when increasing from 100 to 1 k users. Moreover, as the number of users increases, the fit of the Gaussian model for income and age is two times better (JS of 0.05 bits) than for education (JS of 0.1 bits). The main reason is that education has more data points with large differences between actual and approximated distributions than income and age (as shown in FIG. 5A-FIG. 5I).

These results indicate that, for non-uniform distributions, the Gaussian approximation is accurate with a relatively small number of users (about 100). It is interesting to study this result in light of the central limit theorem. The central limit theorem states that the arithmetic mean of a sufficiently large number of variables will tend to be normally distributed. In other words, a Gaussian approximation quickly converges to the original distribution and this confirms the validity of the experiments. This also means that a customer can obtain accurate models even if it requests aggregates about small groups of users. In other words, collecting data about more than 1 k users does not significantly improve the accuracy of approximations, even for more extreme distributions.

Information Leakage.

One can compare the divergence between Gaussian approximations and uniform distributions to measure the information leakage of different attributes. FIG. 6B shows the sensitivity for each attribute with a varying number of users. Observe that the amount of information leakage stabilizes for all attributes after a given number of participants. In particular, education and age reach a maximum information leakage with 1 k users, whereas 10 k users are required for income to achieve the same leakage.

Overall, observe that education is by far the attribute with the largest distance to the uniform distribution, and therefore arguably the most valuable one. In comparison, income and age are 50% and 75% less “revealing.” Information leakage for age decreases from 100 to 1 k users, as age distribution in the dataset tends towards a uniform distribution. In contrast, education and income are significantly different from a uniform distribution. An important observation is that the amount of valuable information does not increase monotonically with the number of users: For age, it decreases by 30% when the number of users increases from 100 to 1 k, and for education it decreases by 3% when transitioning from 10 k to 5 k users.

These findings show that larger user samples do not necessarily provide better discriminating features. This also shows that users should not decide whether to participate in the protocol solely based on a fixed threshold over total participants, as this may prove to leak slightly more private information.

Overhead.

The inventors also measure the computation overhead for both users and the aggregator. For each user, one execution of the protocol requires 0.284 ms (excluding communication delays), out of which 0.01 ms are spent for the profile generation, 0.024 ms for the feature extraction, 0.026 ms for the differential-privacy noise addition, and 0.224 ms for encryption of the noisy attribute. In general, user profiles are not subject to change within short time intervals, thus suggesting that user-side operations could be executed on resource-constrained devices such as mobile phones.

From FIG. 6C, observe that the aggregator requires about one second to complete its phases when there are only 10 users, 1.5 min with 100 users, 15 min with 1 k users, and 27.7 h for 100 k users. Note, however, that running times can be remarkably reduced using algorithmic optimization and parallelization, which is part of future work. In the results, decryption is the most time-consuming operation for the aggregator as it incurs O(N·Mⱼ). This could be reduced to O(\sqrt{(N·Mⱼ)} by using the Pollard's Rho method for computing the discrete logarithm. Also, one can speed up decryption by splitting decryption operations across multiple machines (e.g., the underlying algorithm is highly-parallelizable).

Pricing.

The price of an attribute aggregate depends on the number of contributing users, the amount of information leakage, and the cost of the attribute. In an implementation, each attribute j has a unit cost of 1 and the aggregator takes a commission wⱼ. There can be three types of privacy sensitivities λ: (i) a uniform random distribution of privacy sensitivities λ_{i,j} for each user i and for each attribute j, (ii) an individual privacy sensitivity λᵢ for each user (same across different attributes), and (iii) an all-share scenario (λᵢ=0 and all users contribute). The commission percentage is wⱼ=w=0.1.

FIG. 6D shows the average revenue generated from one attribute by the aggregator and by users. Observe that user revenue is small and does not increase with the number of participants. In contrast, the aggregator revenue increases linearly with the number of participants. In terms of privacy sensitivities, observe that with higher privacy sensitivities (λᵢ>0), fewer users contribute, thus generating lower revenue overall and per user. For example, users start earning revenue with 10 participants in the all-share scenario, but more users are required to start generating revenue if users adopt higher privacy sensitivities.

Observe that users have an incentive to participate as they earn some revenue (rather than not benefiting at all), but the generated revenue does not generate significant income. Thus, it might encourage user participation from biased demographics (e.g., similar to Amazon Mechanical Turk). In contrast, the aggregator has incentives to attract more users, as its revenue increases with the number of participants. However, customers have an incentive to select fewer users because cost increases with the number of users, and 100 users provide as good an aggregate as 1000 users. This is an intriguing result, as it encourages customers to focus on small groups of users representative of a certain population category.

### Security

Passive Adversary.

To ensure privacy of the personal user attributes, the framework relies on the security of the underlying encryption and differential-privacy methods. Hence, no passive adversary (e.g., a user participating in the monetization protocol, the data aggregator or an external party not involved in the protocol) can learn any of the user attributes. This assumes that the system has performed the key setup phase correctly and that one has chosen a suitable algebraic group (satisfying the DDH assumption) with a large enough prime order (e.g., 1024 bits or more).

Active Adversary.

The framework is resistant to collusion attacks among users and between a subset of users and the aggregator, as each user i encrypts its attribute values with a unique and secret key sᵢ. However, pollution attacks, which try to manipulate the aggregated result by encrypting out-of-scope values, can affect the aggregate result of the protocol. Nevertheless, one can mitigate such attacks by including, in addition to encryption, range checks based on efficient (non-interactive) zero-knowledge proofs of knowledge. Each user could submit, in addition to the encrypted values, a proof that such values are indeed in the plausible range specified by the data aggregator. However, even within a specific range, a user can manipulate its contributed value and thus affect the aggregate. Although nudging users to reveal their true attribute value is an important challenge, it is outside of the scope of this disclosure.

### Exemplary Apparatus

FIG. 7 presents a block diagram illustrating an exemplary apparatus 700 for privacy-preserving aggregation of data, in accordance with an embodiment. Apparatus 700 can comprise a plurality of modules which may communicate with one another via a wired or wireless communication channel. Apparatus 700 may be realized using one or more integrated circuits, and may include fewer or more modules than those shown in FIG. 7. Further, apparatus 700 may be integrated in a computer system, or realized as a separate device which is capable of communicating with other computer systems and/or devices.

Specifically, apparatus 700 can comprise any combination of attribute collector module 702, encryption module 704, utility usage meter 706, and aggregator-device communication module 708. Note that apparatus 700 may also include additional modules and data not depicted in FIG. 7, and different implementations may arrange functionality according to a different set of modules. Embodiments of the present invention are not limited to any particular arrangement of modules.

Some implementations may include attribute collector module 702 which collects user attribute data. Encryption module 704 encrypts data to send to aggregator 122. Some implementations may include utility usage meter 706 which measures electricity, water, or other utility consumption levels. Aggregator-device communication module 708 sends the encrypted data to aggregator 122.

### Exemplary System

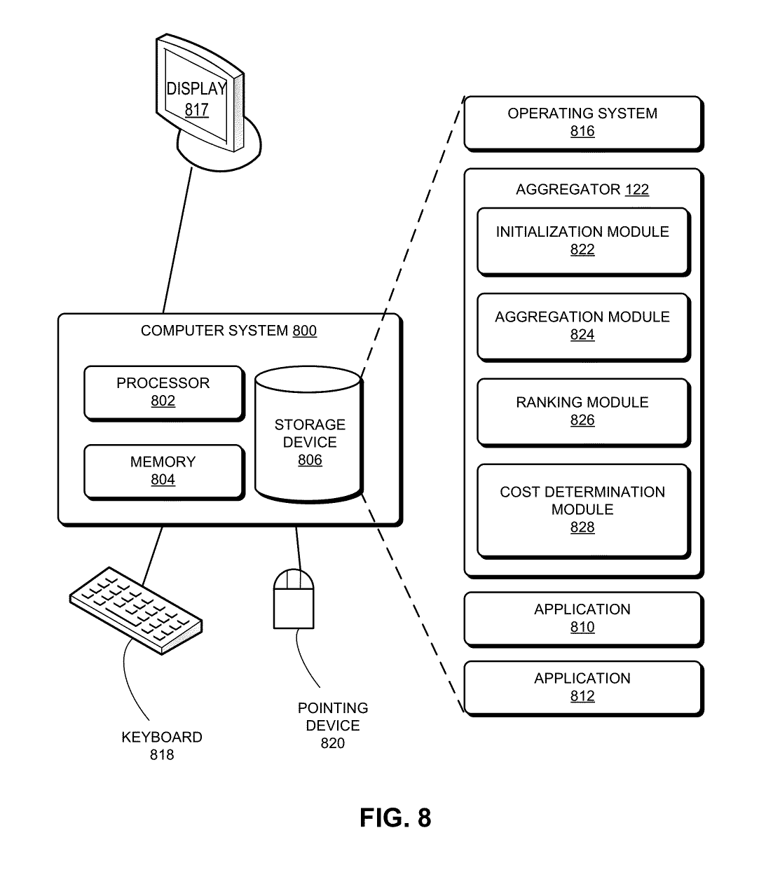

FIG. 8 illustrates an exemplary computer system that may be running a data aggregator, in accordance with an embodiment. In one embodiment, computer system 800 includes a processor 802, a memory 804, and a storage device 806. Storage device 806 stores a number of applications, such as applications 810 and 812 and operating system 816. Storage device 806 also stores code for aggregator 122, which may include components such as initialization module 822, aggregation module 824, ranking module 826, and cost determination module 828. Initialization module 822 executes the initialization operation of FIG. 3A. Aggregation module 824 executes the aggregation operations and generates the probability distribution functions. Ranking module 826 computes the JS divergence values and ranks distributions and associated attributes. Cost determination module 828 determines the cost of the aggregate data.

During operation, one or more applications, such as aggregation module 824, are loaded from storage device 806 into memory 804 and then executed by processor 802. While executing the program, processor 802 performs the aforementioned functions. Computer and communication system 800 may be coupled to an optional display 817, keyboard 818, and pointing device 820.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-executable method for privacy-preserving aggregation of encrypted data, comprising:
distributing secret keys to a plurality of devices;
receiving at least a pair of encrypted vectors from each device of a subset of the plurality of devices, wherein one of the encrypted vectors is associated with a set of numerical values and the other encrypted vector is associated with corresponding square values of the set of numerical values, each pair of encrypted vectors encrypted using a respective secret key distributed to a device of the plurality of devices;
computing, for each pair of encrypted vector elements associated with a numerical value and a square of the numerical value, a mean and variance of a probability density function; and
generating a plurality of probability density functions based on the computed mean and variance values.

2. The method of claim 1, wherein a sum of the respective secret keys distributed to each of the plurality of devices plus a secret key of an aggregator is equal to zero.

3. The method of claim 1, wherein generating the plurality of probability density functions comprises generating one or more probability density functions of Gaussian distributions.

4. The method of claim 1, wherein the encrypted vectors are received from users associated with the devices in exchange for a benefit of economic value to the users as part of a monetizing and/or advertising program.

5. The method of claim 1, wherein computing the mean and variance further comprises computing intermediate values {Vⱼ, Wⱼ} by computing the expressions:
Vⱼ=H(t)^{s}^{₀}Πᵢ₌₁^{N}c_{i,j}
Wⱼ=H(t)^{s}^{₀}Πᵢ₌₁^{N}b_{i,j}
such that b_{i,j} and c_{i,j} represent the encrypted data of each user i for an attribute j in a group of N users, s₀ represents the secret key for an aggregator, and H(t) represents a hash function at time t.

6. The method of claim 5, wherein computing the mean \hat{μ}ⱼ and the variance \hat{σ}ⱼ² associated with an attribute j comprises computing the expressions:
$${\hat{μ}}_{j} = \frac{{log}_{g} ( {v}_{j} )}{N}$$
$${\hat{σ}}_{j}^{2} = \frac{{log}_{g} ( {w}_{j} )}{N} - {\hat{μ}}_{j}^{2}$$
such that g represents the generator and N represents a number of users.

7. A computer-readable storage medium storing instructions that when executed by a computer cause the computer to perform a method for privacy-preserving aggregation of encrypted data, the method comprising:
distributing secret keys to a plurality of devices;
receiving at least a pair of encrypted vectors from each device of a subset of the plurality of devices, wherein one of the encrypted vectors is associated with a set of numerical values and the other encrypted vector is associated with corresponding square values of the set of numerical values, each pair of encrypted vectors encrypted using a respective secret key distributed to a device of the plurality of devices;
computing, for each pair of encrypted vector elements associated with a numerical value and a square of the numerical value, a mean and variance of a probability density function; and
generating a plurality of probability density functions based on the computed mean and variance values.

8. The computer-readable storage medium of claim 7, wherein a sum of the respective secret keys distributed to each of the plurality of devices plus a secret key of an aggregator is equal to zero.

9. The computer-readable storage medium of claim 7, wherein generating the plurality of probability density functions comprises generating one or more probability density functions of Gaussian distributions.

10. The computer-readable storage medium of claim 7, wherein the encrypted vectors are received from users associated with the devices in exchange for a benefit of economic value to the users as part of a monetizing and/or advertising program.

11. The computer-readable storage medium of claim 7, wherein computing the mean and variance further comprises computing intermediate values {Vⱼ, Wⱼ} by computing the expressions:
Vⱼ=H(t)^{s}^{₀}Πᵢ₌₁^{N}c_{i,j}
Wⱼ=H(t)^{s}^{₀}Πᵢ₌₁^{N}b_{i,j}
such that b_{i,j} and c_{i,j} represent the encrypted data of each user i for an attribute j in a group of N users, s₀ represents the secret key for an aggregator, and H(t) represents a hash function at time t.

12. The computer-readable storage medium of claim 7, wherein computing the mean \hat{μ}ⱼ and the variance \hat{σ}ⱼ² associated with an attribute j comprises computing the expressions:
$${\hat{μ}}_{j} = \frac{{log}_{g} ( {v}_{j} )}{N}$$
$${\hat{σ}}_{j}^{2} = \frac{{log}_{g} ( {w}_{j} )}{N} - {\hat{μ}}_{j}^{2}$$
such that g represents the generator and N represents a number of users.

13. A computing system for privacy-preserving aggregation of encrypted data, the system comprising:
one or more processors,
a computer-readable medium coupled to the one or more processors having instructions stored thereon that, when executed by the one or more processors, cause the one or more processors to perform operations comprising:
distributing secret keys to a plurality of devices;
receiving at least a pair of encrypted vectors from each device of a subset of the plurality of devices, wherein one of the encrypted vectors is associated with a set of numerical values and the other encrypted vector is associated with corresponding square values of the set of numerical values, each pair of encrypted vectors encrypted using a respective secret key distributed to a device of the plurality of devices;
computing, for each pair of encrypted vector elements associated with a numerical value and a square of the numerical value, a mean and variance of a probability density function; and
generating a plurality of probability density functions based on the computed mean and variance values.

14. The computing system of claim 13, wherein a sum of the respective secret keys distributed to each of the plurality of devices plus a secret key of an aggregator is equal to zero.

15. The computing system of claim 13, wherein generating the plurality of probability density functions comprises generating one or more probability density functions of Gaussian distributions.

16. The computing system of claim 13, wherein the encrypted vectors are received from users associated with the devices in exchange for a benefit of economic value to the users as part of a monetizing and/or advertising program.

17. The computing system claim 13, wherein computing the mean and variance further comprises computing intermediate values {Vⱼ, Wⱼ} by computing the expressions:
Vⱼ=H(t)^{s}^{₀}Πᵢ₌₁^{N}c_{i,j}
Wⱼ=H(t)^{s}^{₀}Πᵢ₌₁^{N}b_{i,j}
such that b_{i,j} and c_{i,j} represent the encrypted data of each user i for an attribute j in a group of N users, s₀ represents the secret key for an aggregator, and H(t) represents a hash function at time t.

18. The computing system of claim 13, wherein computing the mean \hat{μ}ⱼ and the variance \hat{σ}ⱼ² associated with an attribute j comprises computing the expressions:
$${\hat{μ}}_{j} = \frac{{log}_{g} ( {v}_{j} )}{N}$$
$${\hat{σ}}_{j}^{2} = \frac{{log}_{g} ( {w}_{j} )}{N} - {\hat{μ}}_{j}^{2}$$
such that g represents the generator and N represents a number of users.
